(19) United States
(12) Patent Application Publication
(10) Pub. No.: US 2020/0034042 A1
(43) Pub. Date: Jan. 30, 2020

(54) METHOD FOR WRITING DATA IN A DISTRIBUTED STORAGE SYSTEM

(71) Applicant: BEIJING BAIDU NETCOM SCIENCE AND TECHNOLOGY CO., LTD., Beijing (CN)

(72) Inventor: Jingwei MA, Beijing (CN)

(73) Assignee: BEIJING BAIDU NETCOM SCIENCE AND TECHNOLOGY CO., LTD., Beijing (CN)

(21) Appl. No.: 16/425,318

(22) Filed: May 29, 2019

(30) Foreign Application Priority Data
Jul. 24, 2018 (CN) 2018108175816

(51) Int. Cl. G06F 3/06; G06F 16/17

(52) U.S. Cl. CPC G06F 3/065; G06F 16/1734; G06F 3/0604; G06F 3/067

(57) ABSTRACT

The present disclosure relates to a method for writing data into a distributed storage system. The distributed storage system comprises a memory and a non-transitory storage medium, a replication group at least including a leader is created in the distributed storage system, and the non-transitory storage medium stores a log file and a data file of the leader. The method comprises: receiving, by the leaser, a data writing request; depending on a size of the data to be written, the leader writing the data to be written into the log file of the leader or committing the data to be written into the data file of the leader. The method according to the present disclosure enables reduction of the times of write and elimination of the problem of write amplification.

### CROSS-REFERENCE TO RELATED APPLICATION

This application claims priority to Chinese Patent Application No. 201810817581.6, filed on Jul. 24, 2018, which is incorporated herein by reference in its entirety.

### TECHNICAL FIELD

The present disclosure relates to a distributed storage system, and particularly to method for writing data in a distributed storage system.

### BACKGROUND

In a distributed storage system, data are usually stored in multiple copies to improve the reliability of the storage system. Synchronization of data of the multiple copies is usually achieved through a log file. For example, a raft protocol is a replication group communication protocol, and it communicates in copies in a replication group based on a log form to achieve data consistency.

However, in the prior art, copies belonging to different replication groups are saved on the same disk, and writing of both the log file and the data file requires operation of the disk. This creates problems such as write amplification and random write. Specifically, data is simultaneously written into the log file and data file, that is, user data is written into the log file and data file for multiple times, which causes the problem of write amplification. In addition, the positions of the data file and log file on the disk are not continuous, which also creates a problem of random write. Furthermore, in the storage system, a plurality of accessing processes in a plurality of replication groups usually exist in the storage system and simultaneously perform the write operation of the data file and the log file, which causes a more serious problem of random write.

Taking the raft protocol as an example, the distributed storage system generally includes at least one replication group, and each replication group includes a leader (leader process) and at least one follower (follower process). FIG. 1 shows a data flow of a raft-based distributed storage system. The data writing process in a replication group of the storage system generally includes the following steps:
receiving by the leader a write request sent by the user,
the leader writing data to its own log file;
the leader sends the log to the follower;
the leader sends a commit message, and the leader and follower simultaneously operate on the data file according to the log file to write the data to be written.

The data reading process in the above distributed storage system includes the leader receiving a read request from the client, and the leader reading the data from the data file and returning it to the client.

Data synchronization between the leader and follower is implemented according to the write process of the raft protocol. However, for each process (the leader or follower), the data is written to the disk twice, i.e., written into the log file one time and written into the data file one time. The times of writes increases as the number of followers increases. In addition, writing data into the log file and the data file will cause the problem of random write.

Therefore, it is desirable to provide a distributed storage method that may reduce times of write into the disk and reduce the randomness of write.

### SUMMARY

In view of this, the present disclosure provides a method for writing data into a distributed storage system. The distributed storage system comprises a memory and a non-transitory storage medium, and a replication group at least including a leader is created in the distributed storage system. The non-transitory storage medium stores a log file and a data file of the leader. The method comprises:

receiving, by the leader, a data writing request;

depending on a size of data to be written, the leader writing the data to be written into the log file of the leader or committing the data to be written into the data file of the leader.

According to a preferred embodiment of the present disclosure, in the above method of writing data, the step of, depending on a size of the data to be written, the leader writing the data to be written into the log file of the leader or committing the data to be written to the data file of the leader comprises:

if the size of the data to be written is less than a predetermined value, the leader writing the data to be written into the log file of the leader;

otherwise, the leader committing the data to be written to the data file of the leader.

According to a preferred embodiment of the present disclosure, in the above method for writing data, the leader writing the data to be written into the log file of the leader comprises:

the leader writing the data to be written into the log file of the leader, and upon performing the commit operation, establishing, in the memory, an index pointing to the data written into the log file of the leader.

According to a preferred embodiment of the present disclosure, in the above method for writing data, the leader committing the data to be written to the data file of the leader comprises:

the leader writing the data to be written into the memory, and establishing, in the log file of the leader, an index pointing to the data written into the memory;

upon performing the commit operation, writing the data written into the memory into the data file of the leader.

According to a preferred embodiment of the present disclosure, in the method for writing data, the replication group further comprises a follower, the non-transitory storage medium further stores a log file and a data file of the follower, and the method further comprises:

depending on the size of the data to be written, the follower writing the data to be written into the log file of the follower, or committing the data to be written into the data file of the follower.

According to a preferred embodiment of the present disclosure, in the above method of writing data, the step of, depending on a size of the data to be written, the follower writing the data to be written into the log file of the follower or committing the data to be written to the data file of the follower comprises:

if the size of the data to be written is less than a predetermined value, the follower writing the data to be written into the log file of the follower;

otherwise, the follower committing the data to be written to the data file of the follower.

According to a preferred embodiment of the present disclosure, in the above method for writing data, the follower writing the data to be written into the log file of the follower comprises:

the follower writing the data to be written into the log file of the follower, and upon performing the commit operation, establishing, in the memory, an index pointing to the data written into the log file of the follower.

According to a preferred embodiment of the present disclosure, in the above method of writing data, the follower committing the data to be written to the data file of the follower comprises:

the follower writing the data to be written into the memory, and establishing, in the log file of the follower, an index pointing to the data written into memory;

upon performing the commit operation, writing the data written in the memory into the data file of the follower.

According to a preferred embodiment of the present disclosure, in the above method for writing data, the distributed storage system is a distributed storage system based on a raft protocol.

According to a preferred embodiment of the present disclosure, in the above method of writing data, the predetermined value is 512 KB.

The present disclosure further provides a method for reading data in a distributed storage system. The distributed storage system comprises a memory and a non-transitory storage medium. A replication group at least including a leader is created in the distributed storage system, and the non-transitory storage medium stores a log file and a data file of the leader. Depending on the size of the data to be written, the leader writing data to the log file of the leader in advance, or committing the data to the data file of the leader. The method comprises:

receiving, by the leader, a data reading request;

reading data from the log file or data file of the leader.

According to a preferred embodiment of the present disclosure, in the above method for reading data, the reading data from the log file or data file of the leader comprises:

if an index pointing to data to be read exists in the memory, reading the data from the log file of the leader according to the index;

if the index pointing to the data to be read does not exist in the memory, reading the data from the data file of the leader.

The present disclosure further provides a distributed storage system. The distributed storage system comprises a memory and a non-transitory storage medium, a replication group at least including a leader is created in the distributed storage system, and the non-transitory storage medium stores a log file and a data file of the leader, wherein the leader is configured to perform the following steps:

receiving, by the leader, a data writing request;

depending on a size of the data to be written, the leader writing the data to be written into the log file of the leader or committing the data to be written into the data file of the leader.

According to a preferred embodiment of the present disclosure, in the above distributed storage system, depending on a size of the data to be written, the leader writing the data to be written into the log file of the leader or committing the data to be written to the data file of the leader comprises:

if the size of the data to be written is less than a predetermined value, the leader writing the data to be written into the log file of the leader;

otherwise, the leader committing the data to be written to the data file of the leader.

According to a preferred embodiment of the present disclosure, in the above distributed storage system, the leader writing the data to be written into the log file of the leader comprises:

the leader writing the data to be written into the log file of the leader, and upon performing the commit operation, establishing, in the memory, an index pointing to the data written into the log file of the leader.

According to a preferred embodiment of the present disclosure, in the above distributed storage system, the leader committing the data to be written to the data file of the leader comprises:

the leader writing the data to be written into the memory, and establishing, in the log file of the leader, an index pointing to the data written into the memory;

upon performing the commit operation, writing the data written into the memory into the data file of the leader.

According to a preferred embodiment of the present disclosure, in the above distributed storage system, the replication group further comprises a follower, the non-transitory storage medium further stores a log file and a data file of the follower, and the follower is configured to perform the following steps:

depending on the size of the data to be written, the follower writing the data to be written into the log file of the follower, or committing the data to be written into the data file of the follower.

According to a preferred embodiment of the present disclosure, in the above distributed storage system, depending on a size of the data to be written, the follower writing the data to be written into the log file of the follower or committing the data to be written to the data file of the follower comprises:

if the size of the data to be written is less than a predetermined value, the follower writing the data to be written into the log file of the follower;

otherwise, the follower committing the data to be written to the data file of the follower.

According to a preferred embodiment of the present disclosure, in the above distributed storage system, the follower writing the data to be written into the log file of the follower comprises:

the follower writing the data to be written into the log file of the follower, and upon performing the commit operation, establishing, in the memory, an index pointing to the data written into the log file of the follower.

According to a preferred embodiment of the present disclosure, in the above distributed storage system, the follower committing the data to be written to the data file of the follower comprises:

the follower writing the data to be written into the memory, and establishing, in the log file of the follower, an index pointing to the data written into memory;

upon performing the commit operation, writing the data written in the memory into the data file of the follower.

According to a preferred embodiment of the present disclosure, the distributed storage system is a distributed storage system based on a raft protocol.

According to a preferred embodiment of the present disclosure, in the above distributed storage system, the predetermined value is 512 KB.

According to a preferred embodiment of the present disclosure, in the above distributed storage system, the leader is further configured to perform the following steps:

receiving, by the leader, a data reading request;

reading data from the log file or data file of the leader.

According to a preferred embodiment of the present disclosure, in the above distributed storage system, the reading data from the log file or data file of the leader comprises:

if an index pointing to data to be read exists in the memory, reading the data from the log file of the leader according to the index;

if the index pointing to the data to be read does not exist in the memory, reading the data from the data file of the leader.

The present disclosure further provides a device, the device comprising:

one or more processors,

a storage for storing one or more programs,

the one or more programs, when executed by said one or more processors, enable said one or more processors to implement the above method.

The present disclosure further provides a storage medium containing computer executable instructions which, when executed by a computer processor, performs the above method.

As can be seen from the above solutions, the method according to the present disclosure employs different write policies for data of different sizes so that, for example, small blocks of data can be sequentially written to the log file, thereby reducing the randomness of the write. Therefore, the method of the present disclosure may fully exploit the sequential write performance of the disk. In addition, the data is not written into both the log file and the data file of the disk, but is written into one of the log file and the data file. Therefore, the method of the present disclosure makes it possible to reduce the times of writing data into the non-transitory storage medium, thereby improving the writing efficiency of the non-transitory storage medium and reducing the write randomness.

### BRIEF DESCRIPTION OF THE DRAWINGS

FIG. 1 is a schematic diagram of a data flow of a distributed storage system based on a raft protocol in the prior art;

FIG. 2 is a flowchart of a method for writing data in a distributed storage system according to an embodiment of the present disclosure;

FIG. 3 is a flowchart of a method for writing data in a distributed storage system according to another embodiment of the present disclosure;

FIG. 4 is a schematic diagram of a data storage structure in a distributed storage system according to an embodiment of the present disclosure;

FIG. 5 is a schematic diagram of a method for reading data in a distributed storage system according to an embodiment of the present disclosure;

FIG. 6 is a schematic structural diagram of a distributed storage system according to an embodiment of the present disclosure;

FIG. 7 shows a block diagram of an exemplary computer system/server adapted to implement embodiments of the present disclosure.

### DETAILED DESCRIPTION

The present disclosure will be described in detail below with reference to figures and specific embodiments to make the objects, technical solutions and advantages of the present disclosure more apparent.

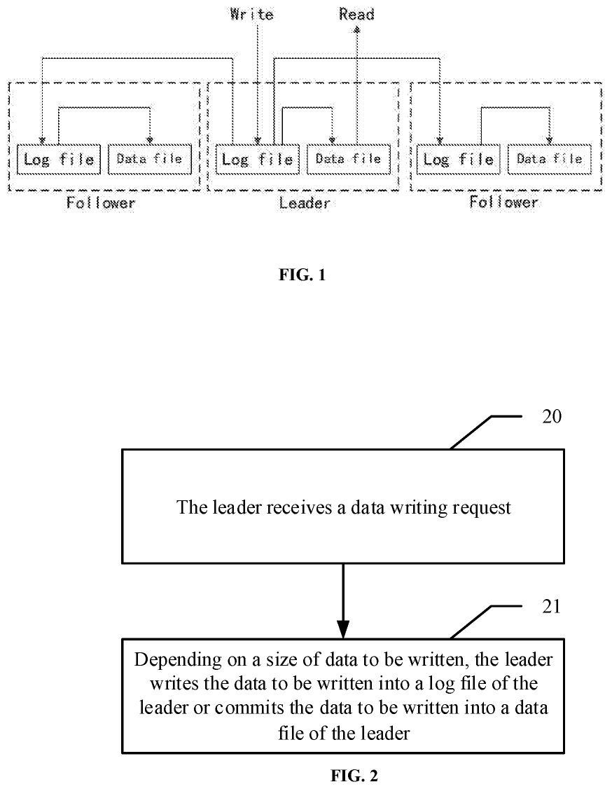

FIG. 1 is a data flow of a distributed storage system based on a raft protocol in the prior art. Whenever new data is to be written, both the leader and follower in FIG. 1 write data in their respective log files and data files. The core idea of the present disclosure is, depending on the size of the data to be written, writing data to a log file in a non-transitory storage medium or writing data to a data file in a non-transitory storage medium, thereby avoiding secondary write of the data (i.e., the data is written into both the log file and the data file) and eliminating the write amplification problem. The present disclosure is particularly applicable to a distributed storage system that uses a disk as a non-transitory storage medium. Since the efficiency of writing into the disk is low, eliminating some amplification problems makes it possible to use the disk more efficiently and reduce the randomness of the write.

FIG. 2 is a flowchart of a method for writing data into a distributed storage system according to an embodiment of the present disclosure. The distributed storage system includes a memory and a non-transitory storage medium. A replication group that at least includes the leader is created in the distributed storage system. The leader may be used to access data in the distributed storage system. The log file and data file of the leader are saved on the non-transitory storage medium. The distributed storage system may include a plurality of replication groups for different applications. In the present embodiment, only the leader in one replication group is described. As shown in FIG. 2, the method according to the embodiment may include the following steps:

In step 20, the leader receives a data writing request. The data writing request may come from a client device or from a hypervisor of the distributed storage system. The data writing request may include data to be written, and may also include the position of the data to be written.

In step 21, depending on the size of the data to be written, the leader writes the data to be written into the log file of the leader or commits the data to be written to the data file of the leader. That is, whether the data is written to the log file or the data file depends on the size of the data.

As can be seen from the flow in FIG. 2, the data is not written into both the log file and the data file of the non-transitory storage medium, but is written into one of the log file and the data file. Whether the data is ultimately written into the log file or the data file depends on the size of the data. Therefore, the method of the embodiment may effectively reduce the times of data writing, thereby improving data writing efficiency.

According to a preferred embodiment, step 21 in FIG. 2 may further include the following step:

if the size of the data to be written is less than a predetermined value, the leader writes the data to be written to the log file of the leader; otherwise, the leader commits the data to be written to the data file of the leader.

The data size is relative. In some situations, small data considered in some situations may be considered as large data in other situations. According to the present embodiment, the size of the predetermined value may be adjusted according to different application scenarios to implement an optimal storage policy. According to a preferred embodiment, the predetermined value is 512 KB. In fact, for general user data, setting the predetermined value to 512 KB may achieve an ideal data storage strategy. According to the present embodiment, all data written into the log file is small block data, so that the sequential write performance of the disk can be fully exploited.

According to a preferred embodiment, the leader writing the data to be written into the log file of the leader in step 21 may include: the leader writes the data to be written into the log file of the leader, and when performing the commit operation, establishing in a memory an index pointing to the data written into the log file of the leader.

Therefore, when a file is finally written into the log file of the leader, the index pointing to the data is written in memory to ensure that the data may be found from the log file through the index.

According to a preferred embodiment, the leader committing the data to be written to the data file of the leader in step 21 may include: the leader writes the data to be written into the memory, and establishes, in the log file of the leader, an index pointing to the data written into the memory; upon performing the commit operation, writes the data written into the memory into the data file of the leader. The data to be written is thus written into the data file from the memory. At the same time, the log file of the leader is written with an index log pointing to the data to ensure that the data can be found through the index log.

The above embodiment implements sharing of the data in the log file and data file, thereby avoiding repeated write of the data. Therefore, the method according to the present embodiment may effectively reduce the times of write of the data into the disk, and meanwhile ensure the written data may be found when the data is read.

FIG. 3 is a flowchart of a method for writing data in a distributed storage system according to another embodiment of the present disclosure. The distributed storage system includes a memory and a non-transitory storage medium. A replication group is created in the distributed storage system. The replication group includes a leader and a follower. The leader may access the data and the follower may back up the data. The non-transitory storage medium stores the log file and the data file of the leader, as well as the log file and data file of the follower. The distributed storage system may include a plurality of replication groups for different applications. In the present embodiment, only the leader for accessing data in one replication group is described. In general, one replication group only includes one leader. In order to back up the data saved by the leader to enhance the reliability of the storage system, the replication group may further include one or more followers. As shown in FIG. 3, the method according to the present embodiment may include the following steps:

In step 30, the leader receives a data writing request. This step is the same as step 20 in FIG. 2.

In step 31, depending on the size of the data to be written, the leader writes the data to be written into the log file of the leader or submits the data to be written to the data file of the leader. This step is the same as step 21 in FIG. 2.

In step 32, depending on the size of the data to be written, the follower writes the data to be written into the log file of the follower or submits the data to be written to the data file of the follower. Depending on the size of the data to be written, the follower writes the data to be written into the log file of the follower, or writes the data to be written into the memory and writes an index log pointing to the data to be written in the log file of the follower. This step differs from step 31 in that step 32 is performed by the follower.

The follower performs the same steps as the leader, and intends to back up the data to enhance the reliability of the storage system, while reducing the times of write as in the leader.

According to a preferred embodiment, step 32 in FIG. 3 may further include the following step:

if the size of the data to be written is less than a predetermined value, the follower writes the data to be written into the log file of the follower; otherwise, the follower commits the data to be written to the data file of the follower. Therefore, the size of the predetermined value may be adjusted according to different application scenarios to achieve an optimal storage strategy. According to a preferred embodiment, the predetermined value is 512 KB.

According to a preferred embodiment, the follower writing the data to be written into the log file of the follower in step 32 may include: the follower writes the data to be written into the log file of the follower, and when performing the commit operation, establishes, in the memory, an index pointing to the data written to the log file of the follower. The commit operation may be triggered by the leader sending a commit message to the follower. By sending the commit message, the leader may acknowledge the data writing to the follower, thereby ensuring consistency of the data stored by the leader and the follower.

According to a preferred embodiment, the follower writing the data to be written into the data file of the follower in step 32 may include: the follower writes the data to be written into the memory, and establishes, in the log file of the follower, an index pointing to the data written to the memory; upon performing the commit operation, writes the data written into the memory into the data file of the follower. Thus, the data is finally written into the data file of the leader.

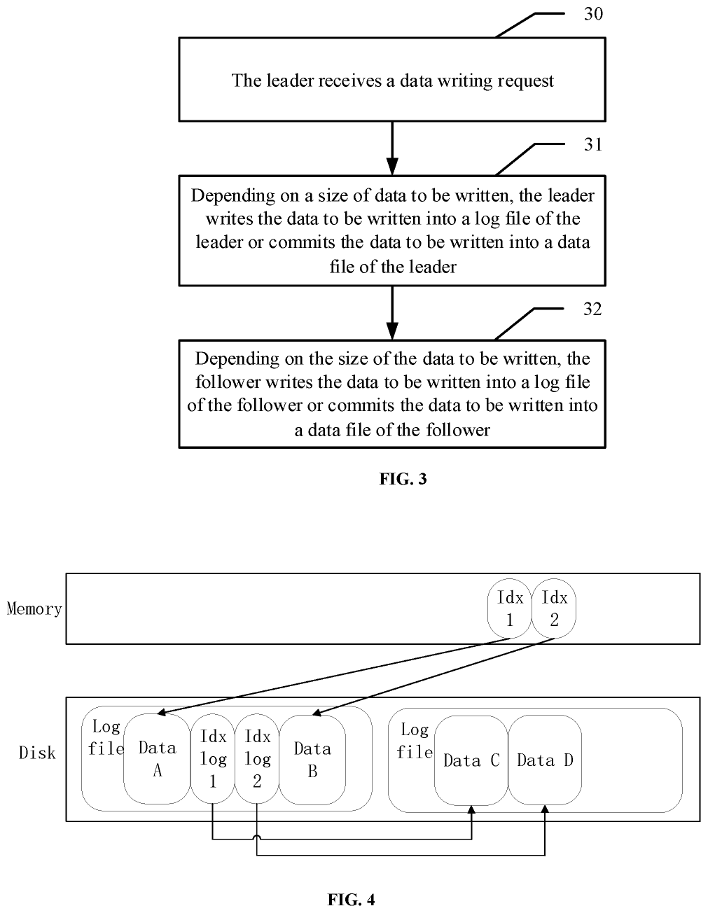

FIG. 4 is a schematic diagram of a data storage structure in a distributed storage system according to an embodiment of the present disclosure. A disk is used as a non-transitory storage medium in this embodiment. However, it should be understood that other types of transient storage media may also be used in the system. The storage system in FIG. 4 includes two indexes idx1 and idx2 respectively pointing to two blocks of data A and B in the log file. The log file includes index logs idxlog1 and idxlog2 pointing to two blocks of data C and D in the data file, respectively. Data A and data B may correspond to data whose size is less than a predetermined value. Data C and data D may correspond to data whose size is greater than or equal to a predetermined value. As can be clearly seen from FIG. 3, the data file does not include the data A and B in the log file. Similarly, the log file does not include the data C and D in the data file. Therefore, the writing method according to the present disclosure avoids secondary writing of data, and the use of disk space is thereby also optimized.

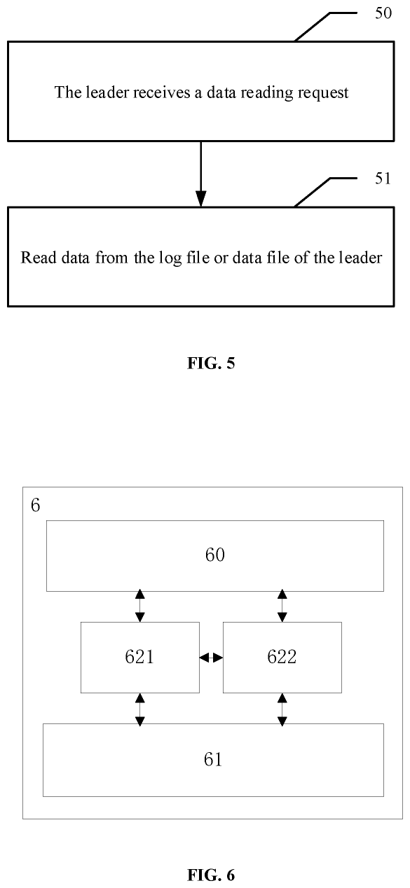

FIG. 5 shows a method for reading data in a distributed storage system according to an embodiment of the present disclosure. The distributed storage system is a distributed storage system that implements the method illustrated in FIG. 2 or FIG. 3. The distributed storage system includes a memory and a non-transitory storage medium. A replication group that at least includes a leader is created in the distributed storage system. The log file and data file of the leader are saved on the non-transitory storage medium. If the replication group further includes one or more followers, the log files and data files of respective followers are also respectively stored on the non-transitory storage medium. However, for a read operation, only the leader can provide read services externally. The follower is only used for a backup purpose and does not provide read services externally. According to the method shown in FIG. 2, depending on the size of the data to be written, the leader writes the data to the log file of the leader in advance, or commits the data to the data file of the leader. The method of reading data according to the present embodiment includes the following steps:

In step 50, the leader receives a data reading request. The data reading request may come from a client device or come from a hypervisor from the distributed storage system. The data reading request may, for example, include a unique identifier of the data to be read.

In step 51, the leader reads data from the log file or data file of the leader.

According to a preferred embodiment, step 51 may include: if there is an index pointing to the data to be read in the memory, reading the data from the log file of the leader according to the index; if there is no index pointing to the data to be read in the memory, reading data from the data file of the leader. This data may be found from the data file through an identifier of the data to be read.

If the data is written into the log file, an index pointing to the data to be read should exist in the memory. The system may find the data from the log file through the index. If the data is written to the data file, the index to the data does not exist in the memory. The system may directly find this data from the data file through the identifier of the data.

The method according to the above embodiments may be applied to any distributed file system based on the log file. For example, the distributed storage system is a distributed storage system based on the raft protocol, wherein the leader is a leader defined in the raft protocol and the follower is a follower defined in the raft protocol.

The above describes the method provided by the present disclosure. The distributed storage system provided by the present disclosure will be described below with reference to the embodiments.

FIG. 6 is a schematic structural diagram of a distributed storage system according to an embodiment of the present disclosure. The distributed storage system is used to execute steps of the above method. As shown in FIG. 6, the distributed storage system 6 includes a memory 60 and a non-transitory storage medium 61. The non-transitory storage medium 61 is typically a magnetic disk. The distributed storage system 6 is composed of at least one host. Typically, the distributed storage system consists of a cluster composed of a plurality of hosts. A replication group 62 is created in the distributed storage system 6. FIG. 6 shows only one replication group for illustration purpose. In fact, distributed storage system 6 may include a plurality of replication groups. The replication group 62 includes a leader 621 for accessing data. The replication group 62 may further include a follower 622 for backing up data. Each replication group generally includes one leader and one or more followers to enhance reliability of the storage system. In FIG. 6, only one leader 621 and one follower 622 in the replication group are shown for illustrative purposes. The non-transitory storage medium 61 stores the log file and data file of the leader 621, as well as the log file and data file of the follower 622. The leader 621 is configured to perform the steps described above and performed by the leader to write the data, to be written into the log file or data file of the leader. Likewise, the follower 622 is also configured to perform the steps described above and performed by the follower, to write (back up) data to be written into the log file or data file of the follower.

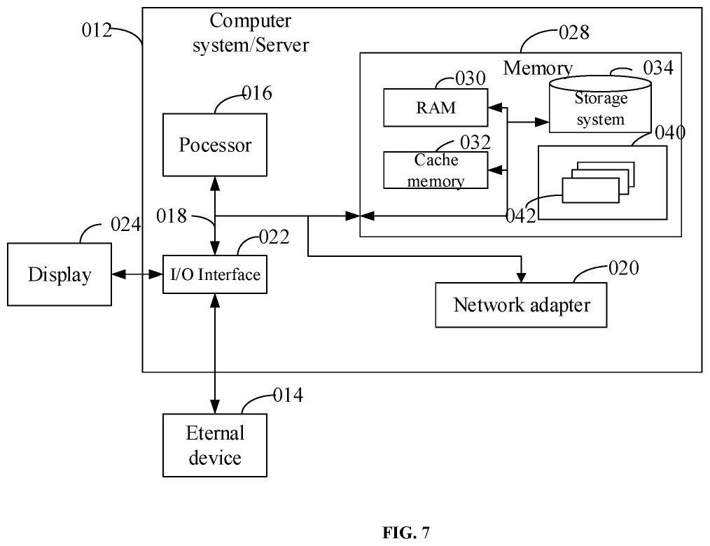

FIG. 7 illustrates a block diagram of an example computer system/server 012 adapted to implement an implementation mode of the present disclosure. The computer system/server 012 shown in FIG. 7 is only an example and should not bring about any limitation to the function and scope of use of the embodiments of the present disclosure.

As shown in FIG. 7, the computer system/server 012 is shown in the form of a general-purpose computing device. The components of computer system/server 012 may include, but are not limited to, one or more processors or processing units 016, a memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 7 and typically called a “hard drive”). Although not shown in FIG. 7, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc.; with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via network adapter 020. As depicted in the figure, the network adapter 020 communicates with the other communication modules of computer system/server 012 via bus 018. It should be understood that although not shown, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes various function applications and data processing by running programs stored in the memory 028, for example, implement the flow of the method according to embodiments of the present disclosure.

The aforesaid computer program may be arranged in the computer storage medium, namely, the computer storage medium is encoded with the computer program. The computer program, when executed by one or more computers, enables one or more computers to execute the flow of the method and/or operations of the apparatus as shown in the above embodiments of the present disclosure. For example, the flow of the method is performed by the one or more processors.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

A computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method for writing data into a distributed storage system, the distributed storage system comprising a memory and a non-transitory storage medium, a replication group at least including a leader being created in the distributed storage system, the non-transitory storage medium storing a log file and a data file of the leader, wherein the method comprises:
receiving, by the leader, a data writing request;
depending on a size of data to be written, the leader writing the data to be written into the log file of the leader or committing the data to be written into the data file of the leader.

2. The method according to claim 1, wherein the step of, depending on a size of the data to be written, the leader writing the data to be written into the log file of the leader or committing the data to be written to the data file of the leader comprises:
if the size of the data to be written is less than a predetermined value, the leader writing the data to be written into the log file of the leader;
otherwise, the leader committing the data to be written to the data file of the leader.

3. The method according to claim 1, wherein the leader writing the data to be written into the log file of the leader comprises:
the leader writing the data to be written into the log file of the leader, and upon performing the commit operation, establishing, in the memory, an index pointing to the data written into the log file of the leader.

4. The method according to claim 1, wherein the leader committing the data to be written to the data file of the leader comprises:
the leader writing the data to be written into the memory, and establishing, in the log file of the leader, an index pointing to the data written into the memory;
upon performing the commit operation, writing the data written into the memory into the data file of the leader.

5. The method according to claim 1, wherein the replication group further comprises a follower, the non-transitory storage medium further stores a log file and a data file of the follower, and the method further comprises:
depending on the size of the data to be written, the follower writing the data to be written into the log file of the follower, or committing the data to be written into the data file of the follower.

6. The method according to claim 5, wherein the step of, depending on a size of the data to be written, the follower writing the data to be written into the log file of the follower or committing the data to be written to the data file of the follower comprises:
if the size of the data to be written is less than a predetermined value, the follower writing the data to be written into the log file of the follower;
otherwise, the follower committing the data to be written to the data file of the follower.

7. The method according to claim 5, wherein the follower writing the data to be written into the log file of the follower comprises:
the follower writing the data to be written into the log file of the follower, and upon performing the commit operation, establishing, in the memory, an index pointing to the data written into the log file of the follower.

8. The method according to claim 5, wherein the follower committing the data to be written to the data file of the follower comprises:
the follower writing the data to be written into the memory, and establishing, in the log file of the follower, an index pointing to the data written into memory;
upon performing the commit operation, writing the data written in the memory into the data file of the follower.

9. The method according to claim 5, wherein the distributed storage system is a distributed storage system based on a raft protocol.

10. The method according to claim 2, wherein the predetermined value is 512 KB.

11. The method according to claim 1, further comprising:
receiving, by the leader, a data reading request;
reading data from the log file or data file of the leader.

12. The method according to claim 11, wherein the reading data from the log file or data file of the leader comprises:
if an index pointing to data to be read exists in the memory, reading the data from the log file of the leader according to the index;
if the index pointing to the data to be read does not exist in the memory, reading the data from the data file of the leader.

13. A device, wherein the device comprises:
one or more processors,
a storage for storing one or more programs,
the one or more programs, when executed by said one or more processors, enable said one or more processors to implement a method for writing data into a distributed storage system, the distributed storage system comprising a memory and a non-transitory storage medium, a replication group at least including a leader being created in the distributed storage system, the non-transitory storage medium storing a log file and a data file of the leader, wherein the method comprises:
receiving, by the leader, a data writing request;
depending on a size of data to be written, the leader writing the data to be written into the log file of the leader or committing the data to be written into the data file of the leader.

14. A storage medium containing computer executable instructions which, when executed by a computer processor, performs a method for writing data into a distributed storage system, the distributed storage system comprising a memory and a non-transitory storage medium, a replication group at least including a leader being created in the distributed storage system, the non-transitory storage medium storing a log file and a data file of the leader, wherein the method comprises:
receiving, by the leader, a data writing request;
depending on a size of data to be written, the leader writing the data to be written into the log file of the leader or committing the data to be written into the data file of the leader.
